(19) United States
(12) Patent Application Publication
(10) Pub. No.: US 2016/0236410 A1
(43) Pub. Date: Aug. 18, 2016

(54) THREE-DIMENSIONAL OBJECT FORMING DEVICE AND THREE-DIMENSIONAL OBJECT FORMING METHOD

(71) Applicant: MIMAKI ENGINEERING CO., LTD., NAGANO (JP)

(72) Inventor: MASARU OHNISHI, NAGANO (JP)

(73) Assignee: MIMAKI ENGINEERING CO., LTD., NAGANO (JP)

(21) Appl. No.: 15/016,265

(22) Filed: Feb. 5, 2016

(30) Foreign Application Priority Data
Feb. 13, 2015 (JP) 2015-026329

(51) Int. Cl. B29C 67/00

(52) U.S. Cl. CPC B29C 67/0059; B29C 67/0088; B29C 67/0085; B29K 2105/0058

(57) ABSTRACT

A three-dimensional object forming device for forming a three-dimensional object that is at least in part colored by an additive manufacturing method includes a head section, a main-scan driver, and a controller. The head section at least discharges ink droplets of a plurality of colored ink for coloring and transparent ink. The controller controls operations of the head section and the main-scan driver so as to form a first color region formed by the first colored ink and the transparent ink and a second color region formed by the second colored ink and the transparent ink on a surface layer part of a lateral side surface of the three-dimensional object. The first region is formed along the lateral side surface on the surface layer part. The second region is formed along the lateral side surface at an inner side of the three-dimensional object with respect to the first region.

### CROSS REFERENCE TO RELATED APPLICATIONS

This application claims the priority benefit of Japanese Patent Application No. 2015-026329, filed on Feb. 13, 2015. The entirety of the above-mentioned patent application is hereby incorporated by reference herein and made a part of this specification.

### TECHNICAL FIELD

The present disclosure relates to a three-dimensional object forming device and a three-dimensional object forming method.

### DESCRIPTION OF THE BACKGROUND ART

In recent years, a three-dimensional object forming device (so-called 3D printer) for forming a three-dimensional object is being widely spread. Further, conventionally, as a method for forming a three-dimensional object by a three-dimensional object forming device, a additive manufacturing method that performs the formation by layering a plurality of layers is known. Moreover, as a method for forming the layers in the additive manufacturing method, a method of forming ink layers using an ink jet head is known. In this case, as the ink jet head, for example, an ink jet head identical or similar to a well-known ink jet head used in cases of printing a two-dimensional image (for example, see Patent Document 1) can be used.

[Patent Document 1] JP 2005-262570 A

### SUMMARY

In the ink jet head, ink droplets of various types of colored ink can be discharged. Due to this, in the case of forming a three-dimensional object as well, various colorings may be performed by using a plurality of colored ink. More specifically, for example, similar to a case of printing a two-dimensional image in full color, coloring (3D decoration) may be performed on the three-dimensional object using colored ink of C (cyan), M (magenta), yellow (Y), and black (K).

Further, in the case of coloring the three-dimensional object, normally, for example, it is desirable to color at least an upper surface and lateral side surfaces of the three-dimensional object. In this case, the upper surface of the three-dimensional object means an uppermost surface of the plurality of layers laminated in the additive manufacturing method. Further, the lateral side surfaces mean surfaces formed in a transverse direction in the additive manufacturing method when a laminate direction along which the plurality of layers is laminated is defined as an up and down direction.

However, conventionally, in a case of performing the formation using the ink jet head with the additive manufacturing method, there has been cases where coloring in a desired color cannot be performed for the color to be applied to the lateral side surfaces. More specifically, for example, color mixing balance of the colored ink becomes inappropriate, where a color change (change in color tone, color fluctuations or the like) may have occurred or suitable color mixing could not be performed, and the color of the used ink appeared as it is in some cases. Further, the coloring on the lateral side surfaces could not be performed appropriately, and internal color (base color) of the three-dimensional object was visible in some cases. Due to this, conventionally, it has been desired to more appropriately perform the formation of the colored three-dimensional object by further improving accuracy of the coloring (3D decoration) of the three-dimensional object. Thus, the present disclosure aims to provide a three-dimensional object forming device and a three-dimensional object forming method that can solve the above problem.

The inventor of the present application conducted a keen study on a cause of the color change and the like that occurs upon coloring the lateral side surfaces of the three-dimensional object. And as the cause thereof, it has been found that a displacement in striking positions of the ink droplets strongly affects the problem.

More specifically, for example, in a case of coloring the upper surface of the three-dimensional object, the coloring may be performed by a method identical to or similar to the case of printing a two-dimensional image. In this case, for example, the appropriate coloring can be performed by discharging the ink droplets of respective colors from the ink jet head for the CMYK colors upon the formation of the uppermost surface of the three-dimensional object.

On the other hand, the lateral side surfaces of the three-dimensional object are formed by having end portions of the plurality of ink layers being overlapped one another. Due to this, to perform the coloring on the lateral side surfaces, not only an operation of forming one layer is required, but also a consideration on how the plurality of ink layers is to be overlapped is required.

Further, in the case of discharging the ink droplets from the ink jet head, the ink droplets receive an influence of air resistance before striking. Due to this, the striking positions of the ink droplets change by the influence of air resistance. Then, for example, in a case of forming an ink layer by causing the ink jet head to perform a main scanning operation (scan operation), a displacement in the striking positions caused by the influence of air resistance becomes large at the end portion of the ink layer. This is assumed, due to the influence of air resistance becoming large at starting timing of the discharge, for example as compared to the case of continuously discharging the ink droplets. Due to this, the influence of air resistance becomes large on the lateral side surfaces of the three-dimensional object where the end portions of the ink layers overlap, and the displacement in the striking position easily becomes problematic.

Further, the displacement in the striking positions of the ink droplets occurs also due to a difference in discharging properties of nozzles in the ink jet head, for example. Due to this, in the case of performing the coloring using a plurality of colors, the displacement in the striking positions is generated also by the differences in the discharging properties of the nozzles for the respective colors in the ink jet head. Further, with coaction of these factors, in the case of performing the coloring on the lateral side surfaces of the three-dimensional object, it is assumed that a difference is generated in the displacements in the striking positions of the ink droplets of the respective colors, which results in the occurrence of color change and the like.

Further, the inventor of the present application further found, in regards to the phenomenon of the occurrence of the color change and the like on the lateral side surfaces due to the displacement in the striking positions, that the use of the same method as the printing of the two-dimensional image for coloring the lateral side surfaces is also one of the causes. Performing the coloring of the lateral side surfaces by the same method as the printing of the two-dimensional image means, for example, to form dots of the colored ink on one surface at a surface layer part of a lateral side surface in the same manner as the case of performing full color expression in a two-dimensional image.

Further, the inventor of the present application has considered, with further keen study, to perform coloring by a method different from the printing of the two-dimensional image in the coloring on the lateral side surfaces. More specifically, for example, instead of forming all of colored ink dots within a same plane of a lateral side surface for all of the plurality of colors (for example, the colors of CMYK), consideration has been given to forming the ink dots in individual planar regions, and laminating the regions of the respective colors. In this case, laminating the regions of the respective colors means for example to form the regions of the respective colors so that the regions of the respective colors are overlapped when seen on the lateral side surfaces of the three-dimensional object. Further, for the regions of the respective colors, consideration has been given to performing the formation by further using transparent clear ink in addition to the respective colored ink, so that presence and absence of use of the respective colored ink can be switched at each position according to the color to be applied on each position in the lateral side surfaces.

By configuring as above, for example, by forming different regions by the respective colored ink, an influence on the color to be applied can appropriately be suppressed even if a difference is generated in the discharging properties of the nozzles for the respective colors in the ink jet head. Further, due to this, the coloring can more appropriately be performed on the lateral side surfaces of the three-dimensional object. To solve the above problem the present disclosure has the following configuration.

(Configuration 1) A three-dimensional object forming device for forming a three-dimensional object that is at least in part colored by an additive manufacturing method, includes: a head section that discharges ink droplets using an ink jet scheme; a main-scan driver that causes the head section to perform a main scanning operation of discharging the ink droplets while moving in a preset main scanning direction; and a controller that controls operations of the head section and the main-scan driver, wherein the head section at least discharges the ink droplets of a plurality of colored ink for coloring and the ink droplets of transparent ink, the plurality of colors for the coloring at least including a first color and a second color that are different from each other, the controller controls the operations of the head section and the main-scan driver so as to form a first color region being a region formed by the first colored ink and the transparent ink and a second color region being a region formed by the second colored ink and the transparent ink on a surface layer part of at least one of lateral side surfaces of the three-dimensional object, and the first region is a region formed along the lateral side surface on the surface layer part, and the second region is a region formed along the lateral side surface at an inner side of the three-dimensional object with respect to the first region.

The plurality of colors for the coloring is colors for example including at least C (cyan), M (magenta), yellow (Y), and black (K). Further, each of the first color and the second is one of CMYK, for example. The surface layer part of the lateral side surface means a portion in a range of the lateral side surface of the three-dimensional object where color thereof is visible from outside, for example. Further, the head section is for example a portion including the ink jet head for the respective colors.

By configuring as above, for example, in the lateral side surface of the three-dimensional object, the first region and the second region being the regions of the respective colors can suitably be formed so as to be overlapped when seen from an outer side of the three-dimensional object. Further, by forming the regions of the respective colors using the transparent clear ink in addition to the respective colored ink, presence and absence of use of the respective colored ink can be switched at each position according to the color to be applied on each position in the lateral side surface.

Further, in this case, by forming individual regions by the respective colored ink, an influence on the color to be applied can suitably be suppressed even in cases where the displacement in the striking positions becomes large due to the influence of air resistance, or where the difference in the discharging properties of the nozzles is generated among the colors. Due to this, by configuring as above, the coloring can more appropriately be performed on the lateral side surface of the three-dimensional object. Further, due to this, the accuracy of the coloring (3D decoration) of the three-dimensional object can be further improved to perform the formation of the colored three-dimensional object more appropriately.

Notably, at least one of the lateral side surfaces of the three-dimensional object for example means a lateral side surface and the like formed on an upstream side of a moving direction of the head section during the main scanning operation. The at least one of the lateral side surfaces may be a lateral side surface on one side or the other side of the main scanning direction. Further, the at least one of the lateral side surfaces may be all of the lateral side surfaces of the three-dimensional object.

(Configuration 2) The plurality of colors for the coloring may at least include the first color, and the second color, a third color, and a fourth color that are different from each other, the controller may control the operations of the head section and the main-scan driver so as to further form a third color region being a region formed by the third colored ink and the transparent ink and a fourth color region being a region formed by the fourth colored ink and the transparent ink on the surface layer part of the lateral side surface, and the third region may be a region formed along the lateral side surface at the inner side of the three-dimensional object with respect to the second region, and the fourth region may be a region formed along the lateral side surface at the inner side of the three-dimensional object with respect to the third region.

Each of the first to fourth colors is one of the CMYK colors, for example. By configuring as above, for example, even in cases of using even a larger number of colored ink, the coloring can be performed more appropriately on the lateral side surface of the three-dimensional object. Further, due to this, the formation of the colored three-dimensional object can be performed more appropriately.

(Configuration 3) The controller may cause the head section to discharge the ink droplets of the first color and the transparent color so that a total amount of the first colored ink and the clear ink comes to be of a certain amount at each part of the first region. In this case, similarly for the other regions (for example, second to fourth regions) such as the second region, it is preferable to cause the head section to discharge the ink droplets of the respective colors and the transparent color so that the total amounts of the respective colored ink and the clear ink come to be of the certain amounts.

In the case of performing the coloring using the plurality of colored ink, for example, various colors will be expressed by mixing the plurality of colors by a subtractive color mixing method. Then, in this case, the discharging amounts of the respective colored ink are set suitably according to the color to be expressed.

However, for example, if the ink amounts vary depending on their locations in the regions of the respective colors, widths of the regions change depending on their positions. Then, in this case, the lamination of the regions of the respective colors with high accuracy may become difficult. Further, it may become difficult to form the three-dimensional object with high accuracy. Moreover, in this case, for example, an undesired surface roughness may be generated on the lateral side surface of the three-dimensional object. Further, by the generation of such a surface roughness, an influence may be imposed on the color of the lateral side surface of the three-dimensional object.

With respect to this, by configuring as above, the regions of the respective colors can be formed more appropriately with a uniform width. Further, due to this, for example, the formation of the colored three-dimensional object can be performed more appropriately.

Notably, coming to be of the certain amount for the total amount of each colored ink (for example, the first colored ink) and the transparent ink means for example to be of an amount within a certain range that predeterminedly accounts for error. Further, the ink amount may for example be an ink amount per preset unit area.

(Configuration 4) The controller may cause the head section to discharge the ink droplets of one of the first color and the transparent color for each position in the first region in accordance with a color to be applied onto the lateral side surface of the three-dimensional object. In this case, similarly for the other regions (for example, second to fourth regions) such as the second region, it is preferable to cause the head section to discharge the ink droplets of the respective colors or the transparent color for each position in the regions of the respective colors in accordance with a color to be applied onto the lateral side surface of the three-dimensional object. Further, each position in the regions of the respective colors means a position of a three-dimensional pixel (voxel).

By configuring as above, for example, at respective portions in the regions of the respective colors, the total amounts of the colored ink and the transparent ink can suitably be adjusted to certain amounts. Further, due to this, for example, the formation can be performed more appropriately in the regions of the respective colors with the uniform width.

(Configuration 5) A sub-scan driver that moves the head section relative to the three-dimensional object in a sub scanning direction that intersects perpendicularly with the main scanning direction may be further provided, wherein the head section may include: a first head being an ink jet head for discharging the ink droplets of at least the first color; and a second head being an ink jet head for discharging the ink droplets of at least the second color, and the second head may be arranged so that its position in the sub scanning direction does not overlap with that of the first head.

By configuring as above, for example, the first region, the second region, and the like can suitably be formed by repeating the main scanning operations with sub scanning operations in between. Further, due to this, for example, the formation of the colored three-dimensional object can be performed more appropriately.

Notably, in addition to the first head and the second head, for example, the head section may further include a third head being an ink jet head that discharges ink droplets of at least a third color, and a fourth head being an ink jet head that discharges ink droplets of at least a fourth color. In this case, each of the first to fourth heads is arranged so that its position in the sub scanning direction does not overlap with the others.

Further, in addition to the first to fourth heads, for example, the head section may further include a plurality of clear-ink heads that each discharges ink droplets of clear ink. In this case, each of the plurality of clear-ink heads is arranged along the main scanning direction with their positions in the sub scanning direction aligned with respect to each of the first to fourth heads. Further, the head section may further include an ink jet head for formation which discharges ink for forming an inside of the three-dimensional object.

(Configuration 6) An ultraviolet light source that irradiates ultraviolet light may further be provided, wherein the head section may discharge ink droplets of ultraviolet curing ink as the ink droplets of each of the plurality of colors for the coloring and the transparent color, the ultraviolet light source may cure ink dots formed by struck ink to a half-cured state in which curing is not complete, upon when the ink droplets of the first color strikes and when the ink droplets of the second color strikes, and each time one ink layer of a preset thickness is formed, the ultraviolet light source may complete the curing of the ink dots configuring the one ink layer by further irradiating the ultraviolet light onto the ink dots configuring the one ink layer before formation of a subsequent ink layer is started.

In a case of configuring as above, for example, the formation of the three-dimensional object can be performed appropriately by using ultraviolet curing ink. Further, in this case, by creating the half-cured state after the ink droplets of the respective colors have struck and before completely curing them, ink layers that are flattened and averaged can be formed. Further, in this case, since the ink layers that are sequentially formed more uniformly covers lower layers, for example, deficits caused upon the ink strike can more appropriately be averaged. Further, due to this, for example, the color change and the visibility of the base color can appropriately be suppressed.

(Configuration 7) In a case where a speed by which the head section moves in the main scanning direction during the main scanning operation is Vh, and an initial speed of ink droplet discharge by the head section is Vt0, Vh may be equal to or less than 1/50 (one-fiftieth) of Vt0. The initial speed of the ink droplet discharge means an initial speed of the ink droplets in their discharging direction, for example. The discharging direction of the ink droplets means a direction that intersects perpendicularly with the main scanning direction, for example.

By configuring as above, for example, striking accuracy of the ink droplets can appropriately be increased. Further, due to this, for example, the regions of the respective colors can be formed more appropriately at higher accuracy. Due to this, by configuring as above, for example, the coloring on the lateral side surfaces of the three-dimensional object can be performed appropriately at higher accuracy. Further, due to this, for example, the formation of the colored three-dimensional object can be performed more appropriately.

(Configuration 8) In a case where a speed by which the head section moves in the main scanning direction during the main scanning operation is Vh, and a speed of the ink droplets upon striking onto the three-dimensional object during formation is Vt, Vh may be equal to or less than 1/20 (one-twentieth) of Vt. The speed Vt of the ink droplets upon striking may be a speed of the ink droplets in the discharging direction, for example.

By configuring as above, for example, striking accuracy of the ink droplets can appropriately be increased. Further, due to this, for example, the regions of the respective colors can be formed more appropriately at higher accuracy. Due to this, by configuring as above, for example, the coloring on the lateral side surfaces of the three-dimensional object can be performed appropriately at higher accuracy. Further, due to this, for example, the formation of the colored three-dimensional object can be performed more appropriately.

(Configuration 9) A three-dimensional object forming method for forming a three-dimensional object that is at least in part colored by an additive manufacturing method, includes: causing a head section that discharges ink droplets using an ink jet scheme to perform a main scanning operation of discharging the ink droplets while moving in a preset main scanning direction; the head section at least discharging the ink droplets of a plurality of colored ink for coloring and the ink droplets of transparent ink; the plurality of colors for the coloring at least including a first color and a second color that are different from each other; controlling an operation of the head section so as to form a first color region being a region formed by the first colored ink and the transparent ink and a second color region being a region formed by the second colored ink and the transparent ink on a surface layer part of at least one of lateral side surfaces of the three-dimensional object, and the first region being a region formed along the lateral side surface on the surface layer part, and the second region being a region formed along the lateral side surface at an inner side of the three-dimensional object with respect to the first region. By configuring as above, for example, advantages similar to those of Configuration 1 can be achieved.

According to the present disclosure, for example, the formation of the colored three-dimensional object can be performed more appropriately.

### BRIEF DESCRIPTION OF DRAWINGS

FIGS. 1A to 1C are diagrams illustrating an example of a three-dimensional object forming device 10 of an embodiment of the present disclosure. FIG. 1A illustrates an example of a configuration of a primary part of the three-dimensional object forming device 10. FIGS. 1B and 1C are diagrams explaining an example of how ink droplets fly.

FIGS. 2A to 2D are diagrams explaining influence of a displacement in striking positions. FIG. 2A is a diagram illustrating an example of a change in shape by the displacement in the striking positions. FIGS. 2B, 2C and 2D are diagrams explaining a change in color generated in a case of performing coloring of a three-dimensional object 50 by a conventional method.

FIGS. 3A to 3C are diagrams illustrating an example of a method of coloring a three-dimensional object 50 in the present embodiment. FIG. 3A illustrates a cross sectional diagram of an entirety of the three-dimensional object 50 colored by the method of the present embodiment. FIG. 3B is an enlarged diagram illustrating an example of a configuration of a coloring region 104 of the present embodiment. FIG. 3C illustrates an example of a configuration of one ink layer 52 configuring the three-dimensional object 50.

FIGS. 4A to 4B are diagrams illustrating an example of a detailed configuration of a head section 12. FIG. 4A illustrates an example of the configuration of the head section 12 together with a plurality of ultraviolet light sources 14. FIG. 4B illustrates a variant of a configuration of coloring sections 302c to k.

### DETAILED DESCRIPTION OF EMBODIMENTS

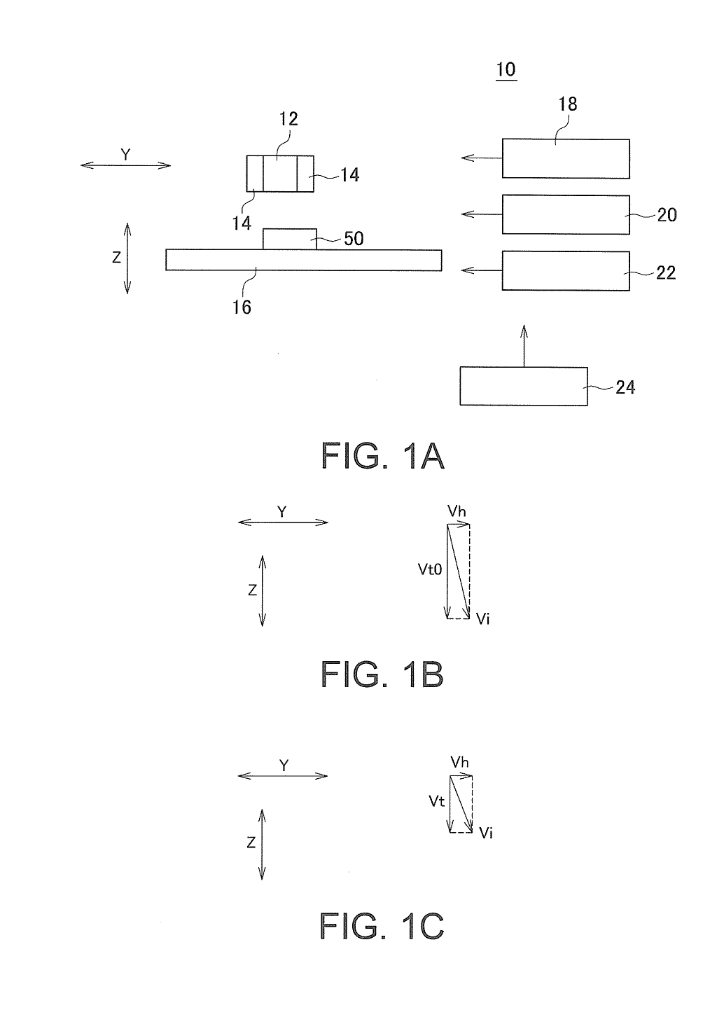

Hereinbelow, embodiments according to the present disclosure will be described with reference to the drawings. FIGS. 1A to 1C illustrate examples of a three-dimensional object forming device 10 of an embodiment of the present disclosure. FIG. 1A illustrates an example of a configuration of a primary part of the three-dimensional object forming device 10. Notably, other than the points described hereinbelow, the three-dimensional object forming device 10 includes characteristics that are identical or similar to those of a well-known three-dimensional object forming device. For example, the three-dimensional object forming device 10 may further include various configurations that are identical or similar to those of the well-known three-dimensional object forming device in addition to the configurations explained hereinbelow.

In the present embodiment, the three-dimensional object forming device 10 is a 3D printer that forms a three-dimensional object using an ink jet scheme, and forms a three-dimensional object 50 that is at least in part colored by an additive manufacturing method. Further, the three-dimensional object forming device 10 includes a head section 12, a plurality of ultraviolet light sources 14, a platform section 16, a main-scan driver 18, a sub-scan driver 20, a Z-direction driver 22, and a controller 24.

The head section 12 is a part that discharges ink droplets of ink to be a material of the three-dimensional object 50 to be formed using the ink jet scheme. In this case, the ink, for example, means liquid to be discharged using the ink jet scheme. The ink jet scheme for example is a scheme of discharging the ink droplets (liquid droplets) from nozzles by using driving elements such as piezoelectric elements or thermal elements.

The head section 12 at least discharges the ink droplets of a plurality of colored ink for coloring, and the ink droplets of transparent ink. Further, in the present embodiment, the head section 12 further discharges the ink droplets of ink for formation other than the aforementioned respective colored ink. Due to this, the head section 12 forms ink layers that configure the three-dimensional object 50.

Further, more specifically, in the present embodiment, the head section 12 is the part including the ink jet heads for the respective colors. Further, the head section 12 discharges the ink droplets of ultraviolet curing ink that cures by irradiation of ultraviolet light as the ink droplets of the respective colors. Further, the head section 12 at least discharges the ink droplets of colored ink for C (cyan), M (magenta), yellow (Y), black (K), for example, as the ink droplets of the plurality of colored ink for the coloring. In this case, the respective colors of CMYK are each an example of a first color, a second color, a third color, and a fourth color that are different from each other. Further, the transparent ink is for example transparent ink with no color. A specific configuration of the head section 12 will be described in further detail later.

The plurality of ultraviolet light sources 14 is light sources for irradiating ultraviolet light for curing the ultraviolet curing ink. In the present embodiment, the plurality of ultraviolet light sources 14 is arranged on both sides of the head section 12 to intervene it in between in the main scanning direction. Further, as the ultraviolet light sources 14, for example, UV LED and the like can suitably be used. The ultraviolet light sources 14 may be light sources other than the UV LED (for example, metal halide lamp and the like).

The platform section 16 is a stage for supporting the three-dimensional object 50 being formed. In the present embodiment, the platform section 16 supports the three-dimensional object 50 at a position facing the head section 12 by mounting the three-dimensional object 50 on its upper surface.

The main-scan driver 18 is a driver that causes the head section 12 to perform a main scanning operation. In this case, the main scanning operation for example means an operation of discharging ink droplets while moving in a preset main scanning direction (Y direction in the drawings). Further, causing the head section 12 perform the main scanning operation means for example means that the ink jet heads provided in the head section 12 to perform the main scanning operation. In the present embodiment, for example, the main-scan driver 18 causes the head section 12 perform the main scanning operation by moving the head section 12 relative to the three-dimensional object 50 having a fixed position.

The sub-scan driver 20 is a driver that causes the head section 12 perform a sub scanning operation. In this case, causing the head section 12 perform the sub scanning operation means for example that the head section 12 is moved in a sub scanning direction (X direction) that intersects perpendicularly with the main scanning direction relative to the three-dimensional object 50. The sub-scan driver 20 for example sequentially changes a positional relationship of the head section 12 and the three-dimensional object 50 in the sub scanning direction by causing the head section 12 perform the sub scanning direction in between the main scanning operations.

Further, the sub-scan driver 20 for example moves the head section 12 relative to the three-dimensional object 50 by moving at least one of the head section 12 and the platform section 16 in the sub scanning direction. In this case, the sub-scan driver 20 may for example move the head section 12 relative to the three-dimensional object 50 having the fixed position. Further, the head section 12 may have a fixed position, and the platform section 16 side may be moved.

The Z-direction driver 22 is a driver that adjusts a distance between the three-dimensional object 50 and the head section 12, and adjusts the distance therebetween by moving at least one of the head section 12 and the platform section 16 in a laminate direction of the ink layers (Z direction in the drawings). In this case, the laminate direction of the ink layers for example means a direction along which the ink layers are sequentially laminated in the additive manufacturing method. Further, more specifically, in the present embodiment, the laminate direction is a direction connecting the head section 12 and the platform section 16. The Z-direction driver 22 for example provides a distance between the head section 12 and the platform section 16 that is greater by one layer of ink layer each time the head section 12 forms one ink layer. Further, due to this, upon the formation of the respective ink layers, the distance between the head section 12 and the three-dimensional object 50 is adjusted to a certain distance.

The controller 24 is for example a CPU of the three-dimensional object forming device 10, and controls operations of respective sections of the three-dimensional object forming device 10. According to the present embodiment, the three-dimensional object 50 can suitably be formed by the additive manufacturing method. Further, by using the plurality of colored ink for coloring, the three-dimensional object 50 can suitably be colored. How the three-dimensional object 50 is colored will be described in detail later.

Now, various characteristics upon performing the formation of the three-dimensional object 50 using the ink jet scheme will be described. FIGS. 1B and 1C are diagrams explaining an example of how ink droplets fly. FIG. 1B illustrates an example of a speed of the ink droplets just after having been discharged from the head section 12.

As in the present example, in the case of causing the head section 12 perform the main scanning operation, the ink droplets receive an influence of the movement of the head section 12. Further, as a result, for example, just after having been discharged, the speed Vi of the ink droplets includes a component in a moving direction of the head section 12. More specifically, for example, when an initial speed of the ink droplet discharge is Vt0 and the moving speed of the head section 12 during the main scanning operation is Vh, the speed Vi of the ink droplets just after having been discharged comes to be of a speed that is obtained by combining the speed Vt0 and the speed Vh, as shown in FIG. 1B.

Notably, in this case, the initial speed of the ink droplet discharge means an initial speed of the ink droplets in their discharging direction, for example. Further, in the present embodiment, the ink droplet discharging direction is a direction perpendicularly intersecting the main scanning direction and the sub scanning direction.

Further, in the case of discharging the ink droplets using the ink jet scheme, a magnitude of the initial speed Vt0 of the ink droplet discharge (absolute value) is normally sufficiently larger than a magnitude of the moving speed Vh of the head section 12. For example, in the present embodiment, the magnitude of Vt0 is preferably 10 times or greater the magnitude of Vh. In this case, an orientation of a speed Vi of the ink droplets just after having been discharged comes to be an orientation close to the discharging direction.

However, from their discharge to striking, the ink droplets fly in the air. Due to this, a flying speed of the ink droplets receives an influence of air resistance. Further, in this case, faster speed results in greater influence of the air resistance. Due to this, the influence of the air resistance on the speed of the ink droplets becomes especially large in the discharging direction.

FIG. 1C shows an example of the speed of the flying ink droplets. A component Vt in the discharging direction in the speed of the ink droplets from after the discharge to the striking of the ink droplets becomes gradually small by the influence of the air resistance. On the other hand, as for the component in the moving direction of the head section 12, the influence of the air resistance thereon is small compared to that of the discharging direction due to being slower compared to the discharging direction. Due to this, if an interval between the head section 12 and the three-dimensional object 50 is sufficiently small, approximately, the influence of the air resistance can be ignored for the component in the moving direction of the head section 12 in the speed Vi of the ink droplets, and regard it as being constant at Vh. Then, in this case, the speed Vi of the ink droplets comes to be of a speed that is obtained by combining the speed Vt and the speed Vh as shown in FIG. 1C. Further, in this case, as can be seen from the drawings, the flying direction of the ink droplets is oriented to be displaced toward the moving direction of the head section 12 as compared to just after the discharge.

Further, the influence of the air resistance received by the ink droplets is not necessarily constant, and may differ depending on positions of the nozzles that discharge the ink droplets and discharge timing. Due to this, a displacement is generated in the striking positions depending on the positions of the nozzles and the discharge timing, and there are cases where an influence is imposed on formation accuracy of the three-dimensional object 50.

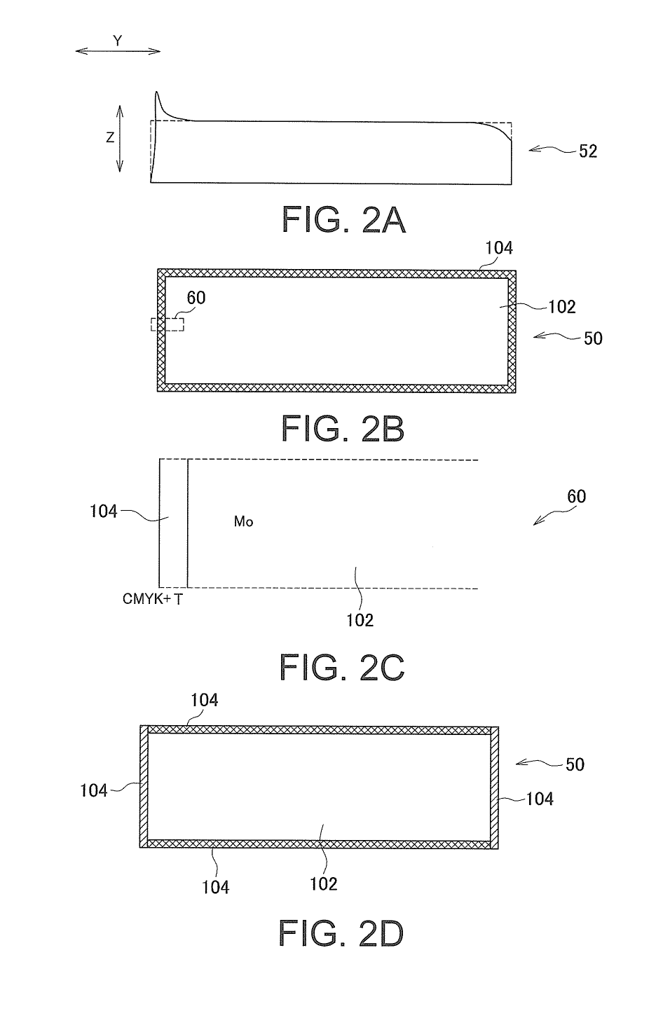

FIGS. 2A to 2D are diagrams explaining an influence of a displacement in striking positions. FIG. 2A is a diagram illustrating an example of a shape change by the displacement in the striking positions, and illustrates an example of an influence of the displacement in the striking positions generated upon forming one ink layer 52 in a case where the moving direction of the head section 12 in the main scanning operation is set to be a direction from the left side to the right side in the drawing.

As above, the influence of the air resistance received by the ink droplets may differ depending on positions of the nozzles and the discharge timing. More specifically, for example, in a case of forming an ink layer 52 by the additive manufacturing method, the influence of the air resistance becomes especially large in the vicinity of a position where the ink droplets strike first in the main scanning direction (for example, a region that is about a few to ten several dots or so of ink), such as the left side portion in the drawing (front end side). Further, in this case, the striking positions thereof easily are displaced to the right side in the drawing. Due to this, in the vicinity of this position, for example, as compared to an ideal shape shown by a dotted line in the drawing, it easily assumes a state in which a part thereof at a portion on a somewhat inner side of the ink layer 52 is bulged up.

Further, for example, in the vicinity of a position where the ink droplets strike last in the main scanning direction, such as the right side portion in the drawing (rear end side), lack of ink and the like may occur at its end portion (edge portion) by the displacement in the striking positions. Further, as a result, for example, as compared to the ideal shape shown by a dotted line in the drawing, it easily assumes a state in which the ink layer 52 becomes thin at a portion on a somewhat inner side of the ink layer 52.

As above, in the case of causing the head section 12 perform the main scanning operation and forming the three-dimensional object by the additive manufacturing method, there is a case where the shape displacement is generated at the end portions of the ink layer 52 by the displacement in the striking positions. Further, for example, in the case of forming a colored three-dimensional object, the generation of such a shape displacement may lead to an influence on the color of the three-dimensional object. More specifically, for example, in the case of performing the coloring on the three-dimensional object using the conventional method, if the aforementioned displacement is generated in the shapes of the end portions of the ink layers 52, a balance of the respective colored ink at a surface of the three-dimensional object is failed and a color change and the like may occur.

FIGS. 2B, 2C, 2D are diagrams explaining a change in color generated in a case of performing coloring of a three-dimensional object 50 by a conventional method. FIGS. 2B and 2C illustrate an example of the method of performing the coloring on the three-dimensional object 50 using the conventional method. FIG. 2B illustrates a cross sectional diagram of an entirety of the three-dimensional object 50. FIG. 2C is a partially enlarged diagram of the three-dimensional object 50, and illustrates a region 60 shown by a broken arrow in FIG. 2B in an enlarged manner.

In the case of forming the three-dimensional object 50 colored by the additive manufacturing method, for example, decoration on the three-dimensional object 50 may be considered to be performed by forming the surface layer part of the three-dimensional object 50 by the ink for the coloring. More specifically, for example, as shown in FIG. 2B, a coloring region 104 is formed around a forming region 102 configuring the inside of the three-dimensional object 50. In this case, the forming region 102 is a region formed by a predetermined forming ink (base forming ink Mo). Further, as the forming ink, for example, white colored ink and the like may be considered to be used.

Further, the coloring region 104 is a region formed by the coloring ink, such as the CMYK ink, for example. More specifically, in the conventional method, the coloring region 104 may be considered to be colored identical or similar to the case of color printing a two-dimensional image using the CMYK ink on the surface layer part of the three-dimensional object 50. In this case, for example, the color region 104 is formed by forming the dots of the respective colored ink in the same plane along the surface layer part of the three-dimensional object 50.

Notably, upon the formation of the three-dimensional object 50, it is preferable to further use clear ink in addition to the CMYK ink. In this case, the clear ink supplements the ink amount for locations where the CMYK ink amount is small. Due to this, for example, the ink amount per unit area is made constant, and the three-dimensional object 50 can be formed even with higher accuracy.

By configuring as above, for example, the colored three-dimensional object 50 can be formed by performing the decoration on the surface of the three-dimensional object 50 using the CMYK ink and the like. However, in this case, as described above as well, when the displacement is generated in the shapes of the end portions of the ink layers 52 configuring the three-dimensional object 50, the balance of the respective colored ink at the surface of the three-dimensional object 50 may fail and the color change and the like may be generated.

FIG. 2D illustrates an example of the color change and the like generated on the surface of the three-dimensional object 50. As above, in the case of performing the coloring on the three-dimensional object 50, the coloring region 104 is formed at least on the surface layer part of the three-dimensional object 50. Then, in this case, for example, the coloring region 104 is formed on the upper surface and the lower surface, and the lateral side surfaces of the three-dimensional object 50.

Among them, for example on the upper surface and the lower surface, the coloring can be performed suitably by forming the ink layer 52 exposed on the surface for example by the coloring ink. Further, in this case, for example, the ink layer 52 can be formed identical or similar to the case of color printing the two-dimensional image.

However, unlike the upper surface and the lower surface, the lateral side surfaces are surfaces formed by end portions of the plurality of layers 52 to be laminated overlapped in the laminate direction. Due to this, in order to form the coloring region 104 along the lateral side surfaces, the end portions of the plurality of ink layers 52 need to be formed according to the color to be applied.

However, as described using FIG. 2A and the like, the shape change tends to occur at the end portions of the ink layers 52 with the influence of the air resistance becoming large at the front end side and the lack of ink droplets likely occurring at the rear end side. Further, as in the case of using the CMYK ink, in the case of performing the coloring using the plurality of colored ink, characteristics in how the striking positions are displaced normally differ depending on the color, due to the differences in the discharging property of the ink jet heads and the differences in the positions of the ink jet heads. Due to this, at the end portions of the ink layers 52, the shape change and the like occurs in the state where how the striking positions are displaced differs depending on the colors of the ink.

Further, in this case, for example, color mixing balance of the colored ink becomes inappropriate, where a color change (color fluctuations) may occur, or suitable color mixing cannot be performed, and the color of the used ink appears as it is in some cases. Further, the coloring on the lateral side surfaces cannot be performed appropriately, and the color (base color) of the forming region 102 configuring the inside of the three-dimensional object may be visible in some cases.

More specifically, for example, in a case of attempting to perform blue coloring (decoration) by mixing C-color ink and M-color ink, the C color and the M color are mixed at the respective portions configuring the lateral side surfaces and the blue color will be expressed if the striking positions are accurate. However, if the striking positions become inaccurate, the color balance is failed by unevenness in the striking positions of the ink droplets of the respective colors being generated, for example, and the color change may occur, and portions where the C color or the M color as it is appears may be generated. Further, if the displacement in the striking positions is large, the base color may become visible at an unexpected region in some cases.

Further, the lateral side surfaces of the three-dimensional object 50 may in some cases be sloped surfaces and not necessarily vertically upright surfaces, depending on the shape of the three-dimensional object 50 to be formed. Further, in such cases, the problem of the color change and the like tends to occur more easily.

Due to this, in the case of performing the coloring on the three-dimensional object 50 by the conventional method, the color change and the like may occur more easily due to the displacement in the striking positions of the ink droplets. With respect to this, in the present embodiment, the color change and the like is make to occur less even in the case where the striking positions of the ink droplets are displaced, by performing the coloring in a different method from the conventional one. Thus, hereinbelow, the method of coloring the three-dimensional object 50 in the present embodiment will be described.

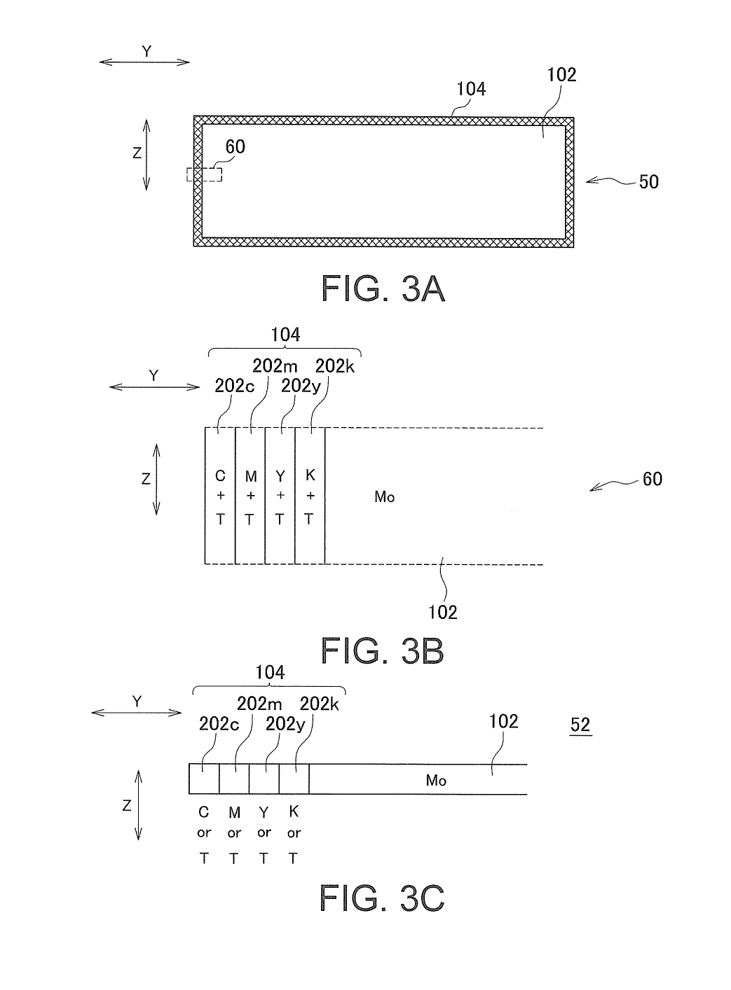

FIGS. 3A to 3C illustrate examples of the method of coloring the three-dimensional object 50 in the present embodiment. FIG. 3A illustrates a cross sectional diagram of an entirety of the three-dimensional object 50 colored by the method of the present embodiment. In the present embodiment as well, the coloring of the three-dimensional object 50 is performed by forming the surface layer part of the three-dimensional object 50 by the coloring ink. In this case, the surface layer part of the three-dimensional object 50 means a portion in a range of each surface surrounding an outer circumference of the three-dimensional object where color thereof is visible from outside, for example. Due to this, the configuration of the entirety of the three-dimensional object 50 comes to be of a configuration in which the coloring region 104 is formed on the periphery of the forming region 102, similar to the case described using FIG. 2B and the like.

On the other hand, the configuration of the coloring region 104 of the present embodiment differs from the configuration described using FIG. 2C and the like. FIG. 3B is an enlarged diagram that illustrates an example of a configuration of the coloring region 104 in the present embodiment, and illustrates the region 60 shown by a broken arrow in FIG. 3A in an enlarged manner. Further, the part illustrated in FIG. 3B is a part that includes at least plural layers of ink layers formed by the additive manufacturing method, for example.

In the present embodiment, the coloring region 104 includes a plurality of specific color regions 202c, 202m, 202c, 202k (hereinbelow denoted as specific color regions 202c to k). Each of the specific color regions 202c to k is a region formed by one colored ink among the coloring ink, and the clear ink. More specifically, in the present embodiment, the specific color region 202c is formed by the C-color ink and the clear ink. The specific color region 202m is formed by the M-color ink and the clear ink. The specific color region 202y is formed by the Y-color ink and the clear ink. Further, the specific color region 202k is formed by the K-color ink and the clear ink.

Notably, in the present embodiment, the specific color region 202c is an example of a first region. Further, the first region is a region formed along the lateral side surface at the surface layer part of the three-dimensional object 50. The specific color region 202m is an example of a second region. The second region is a region formed along the lateral side surface on the inner side of the three-dimensional object 50 with respect to the first region. The specific color region 202y is an example of a third region. The third region is a region formed along the lateral side surface on the inner side of the three-dimensional object 50 with respect to the second region. The specific color region 202k is an example of a fourth region. The fourth region is a region formed along the lateral side surface on the inner side of the three-dimensional object 50 with respect to the third region.

Further, in the present embodiment, the three-dimensional object forming device 10 (see FIG. 1A) forms the specific color regions 202c to k aligned one another as shown on the lateral side surface of the three-dimensional object 50 by controlling the operation of the respective sections of the head section 12 and the main-scan driver 18 using the controller 24. In the variant of the configuration of the three-dimensional object forming device 10, the three-dimensional object forming device 10 may have a different aligning order of the specific color regions 202c to k from the case shown in FIG. 3B. In this case, each of the specific color regions 202c to k becomes an example of the first to fourth regions according to the order along which they are aligned from the outer side to the inner side of the three-dimensional object 50.

In a case of configuring as above, for example, as for the lateral side surface of the three-dimensional object 50, when it is seen from the outside, it is formed by the specific color regions 202c to k being overlapped one another. Further, in this case, the color of each position on the lateral side surface will be the color expressed by the overlap of the specific color regions 202c to k.

Further, in this case, by forming each of the specific color regions 202c to k using the transparent clear ink in addition to the respective colored ink, the presence and absence of use of the respective colored ink can be switched at each position according to the color to be applied on each position in the lateral side surface. Further, due to this, as for the color visually recognized from the outside of the three-dimensional object 50, various colors can be expressed by the subtractive color mixing method by suitably mixing the respective colors of CMYK. Due to this, according to the present embodiment, the coloring in various colors for example can be performed appropriately for each position on the lateral side surface of the three-dimensional object 50.

Further, in this case, since the individual regions (each of the specific color regions 202c to k) are formed by the respective colored ink, the influence on the color to be applied can suitably be suppressed even in cases where the difference in the discharging properties of the nozzles is generated among the colors. More specifically, for example, upon forming the ink layers, even if the shape change as described for example using FIG. 2A is generated, only the shape in the region dedicated for the respective colors changes, so the failure of the color mixing balance of the respective colored ink is less likely to occur. Due to this, in a case of configuring as above, for example, the color change or base color visibility due to the displacement in the striking positions can suitably be suppressed. Further, due to this, for example, the coloring can more appropriately be performed on the lateral side surfaces of the three-dimensional object 50.

Here, as described above, in the present embodiment, each of the specific color regions 202c to k is a region formed by one color ink among the coloring ink, and the clear ink. Further, in this case, for example, the presence and absence of use of the respective colored ink at each position are switched according to the color to be applied on each position in the lateral side surface, so that various colors can be expressed by the subtractive color mixing method.

However, for example, if the ink amounts vary depending on their locations in the specific color regions 202c to k, widths of the regions change depending on their positions. Then, in this case, the lamination of the specific color regions 202c to k with high accuracy may become difficult. Further, for example, it may become difficult to form the three-dimensional object 50 with high accuracy. Moreover, in this case, for example, an undesired surface roughness may be generated on the lateral side surface of the three-dimensional object 50. Further, by the generation of such a surface roughness, an influence may be imposed on the color of the lateral side surface of the three-dimensional object 50.

Due to this, for each of the specific color regions 202c to k, it is preferable to control a total amount of the amount of the corresponding colored ink and the amount of the clear ink come to be of a certain amount. In this case, coming to be of the certain amount means, for example, to be of an amount within a certain range that predeterminedly accounts for error. Further, the ink amount may for example be an ink amount per preset unit area. Further, in this case, more specifically, in the configuration shown in FIG. 1, the controller 24 causes the head section 12 to discharge the ink droplets of the respective colors and the transparent color so that the total amounts of the respective colored ink of CMYK and the transparent ink come to be of the certain amounts respectively in the specific color regions 202c to k.

In a case of configuring as above, for example, the ink amount that is obtained by adding the respective colored ink and the clear ink can be maintained at a preset constant value (for example, (a value close to 100% printing rate) regardless of the color to be applied at each position and the gradation of the respective colors. More specifically, for example, in the case of attempting to express gradation of each color, the amount of the clear ink may be considered to be increased. By configuring as above, for example, the specific color regions 202c to k can each be formed more appropriately with uniform width. Further, due to this, for example, even if the displacement in the striking positions is generated, the color change and the base color visibility can suitably be prevented.

Notably, for each of the specific color regions 202c to k, the entirety of that region will be formed by the corresponding colored ink and the clear ink as described above. However, in the case of focusing on the details of the specific color regions 202c to k, each position in the regions of the respective colors is formed by the colored ink or the clear ink. In this case, each position in the regions of the respective colors means a position of a three-dimensional pixel (voxel), for example.

Thus, subsequently, a detailed configuration of the specific color regions 202c to k will be further described in detail by illustrating an example of the configuration of one ink layer 52. FIG. 3C illustrates an example of a configuration of one ink layer 52 configuring the three-dimensional object 50. In the case of forming the three-dimensional object 50 by the additive manufacturing method using the three-dimensional object forming device 10 having the configuration described using FIG. 1, the ink droplets are discharged to the positions of the respective three-dimensional pixels configuring the one ink layer 52 by performing one or more main scanning operations. Further, in this case, the controller 24 causes the head section 12 discharge the ink droplets of one of the C color or the transparent color according to the color to be applied to the lateral side surface of the three-dimensional object 50 according to each position (position of the three-dimensional pixel) in the specific color region 202c, for example. Further, similarly for each position (position of the three-dimensional pixel) in the specific color region 202m, 202y, 202k, the head section 12 is caused to discharge the ink droplets of one of the color corresponding to that region or the transparent color according to the color to be applied to the lateral side surface of the three-dimensional object 50. By configuring as above, for example, at respective portions in the specific color regions 202c to k, the total amounts of the colored ink and the transparent ink can suitably be adjusted to certain amounts.

As above, in the present embodiment, the colored three-dimensional object 50 can suitably be formed by a method different from the conventional one. Further, by coloring the lateral side surface of the three-dimensional object 50 by forming the specific color regions 202c to k, for example, the color change and the base color visibility and the like can suitably be prevented even in the case where the displacement in the striking positions is generated. Due to this, according to the present embodiment, for example, the accuracy of the coloring (3D decoration) of the three-dimensional object 50 can be further improved to perform the formation of the three-dimensional object 50 more appropriately.

Notably, the lateral side surface of the three-dimensional object 50 explained in FIGS. 3B and 3C is for example a lateral side surface formed on an upstream side of the moving direction of the head section 12 during the main scanning operation. Further, in the present embodiment, it is preferable to color the lateral side surface on a downstream side of the main scanning direction by the similar method as that for the lateral side surface described using FIGS. 3B and 3C and the like. Further, for example, including the lateral side surface and the like on one side and the other side in the sub scanning direction, all of the lateral side surfaces of the three-dimensional object 50 may be colored similar to the lateral side surface described using FIGS. 3B and 3C and the like. By configuring as above, for example, the coloring can suitably be performed on all of the lateral side surfaces of the three-dimensional object 50 using the similar method.

Further, as for the upper surface and the lower surface of the three-dimensional object 50, for example, the coloring can suitably be performed using the similar method as the conventional one. Further, as for the upper surface and the lower surface as well, the coloring may be performed by the similar method as that for the lateral side surface described using FIGS. 3B and 3C and the like.

Further, as for FIG. 3, due to the convenience of the depiction, the surface that is vertically upright relative to the upper surface and the lower surface is shown as the lateral side surface of the three-dimensional object 50. However, in the actual three-dimensional object 50, the lateral side surfaces may be surfaces a part of or all of which is sloped relative to the upper surface and the lower surface. In this case, the specific color regions 202c to k are formed along the shape of the lateral side surfaces.

Further, as for each of the specific color regions 202c to k, the width in the main scanning direction is preferably a width of one or few (for example, one to three or so) three-dimensional pixels. By configuring as above, for example, various colors can suitably be expressed by the specific color regions 202c to k. Further, FIG. 3C shows an example in which the width of each of the specific color regions 202c to k in the main scanning direction is shown by the width of one three-dimensional pixel.

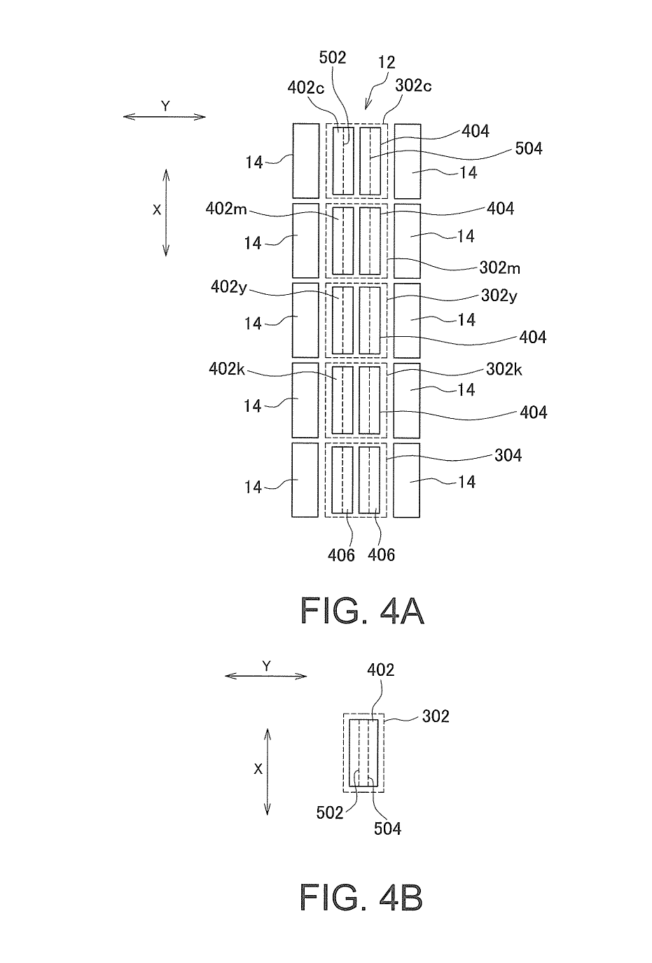

Next, as for the specific configuration of the head section 12 used in the present embodiment will be described in further detail. FIGS. 4A to 4B illustrate examples of the detailed configuration of the head section 12. FIG. 4A illustrates an example of the configuration of the head section 12 together with a plurality of ultraviolet light sources 14.

In the present embodiment, the head section 12 includes a plurality of coloring sections 302c, 302m, 302y, 302k (hereinbelow denoted as coloring sections 302c to k), and a forming section 304. Each of the coloring sections 302c to k is a section for forming the corresponding one of the specific color regions 202c to k (see FIG. 3). In the present embodiment, each of the coloring sections 302c to k and the forming section 304 are arranged aligned along the sub scanning direction with their positions in the main scanning direction matched and not having their positions in the sub scanning direction overlapped.

Further, the coloring section 302c includes a coloring head 402c and a transparent-color head 404. The coloring head 402c is an ink jet head that discharges the ink droplets of the C-color ink among the coloring ink, and includes a nozzle row 502 in which a plurality of nozzles that discharges the ink droplets of the C color is aligned in the sub scanning direction. Further, in the present embodiment, the coloring head 402c is an example of a first head.

The transparent-color head 404 is an ink jet head that discharges the ink droplets of the clear ink, and includes a nozzle row 504 in which a plurality of nozzles that discharges the ink droplets of the transparent color is aligned in the sub scanning direction. The coloring head 402c and the transparent-color head 404 in the coloring section 302c are aligned along the main scanning direction with their positions in the sub scanning direction matched.

Further, the coloring section 302m includes a coloring head 402m and a transparent-color head 404. The coloring head 402m is an ink jet head that discharges the ink droplets of the M-color ink among the coloring ink, and includes a nozzle row 502 in which a plurality of nozzles that discharges the ink droplets of the M color is aligned in the sub scanning direction. Further, in the present embodiment, the coloring head 402m is an example of a second head, and it is arranged with respect to the coloring head 402c that is the example of the first head so that their positions in the sub scanning direction do not overlap. The coloring head 402m and the transparent-color head 404 in the coloring section 302m are arranged along the main scanning direction with their positions in the sub scanning direction matched.

Further, similarly, the coloring section 302y includes a coloring head 402y and a transparent-color head 404. The coloring section 302k includes a coloring head 402k and a transparent-color head 404. Each of the coloring heads 402y, 402k is an ink jet head that discharges the ink droplets of the Y-color or K-color ink among the coloring ink, and includes a nozzle row 502 in which a plurality of nozzles that discharges the ink droplets of the corresponding color is aligned in the sub scanning direction. Further, each of the coloring heads 402y, 402k is an example of a third head and a fourth head, and is arranged with respect to the other ink jet heads among the coloring heads 402c to k so that its position in the sub scanning direction does not overlap. Further, the respective ink jet heads in the coloring sections 302y, 302k are arranged along the main scanning direction with their positions in the sub scanning direction matched as shown in the drawings.

Further, the forming section 304 is a section for forming the forming region 102 (see FIG. 3) configuring the inside of the three-dimensional object 50. In the present embodiment, the forming section 304 includes a plurality of forming heads 406. Each of the forming heads 406 is an ink jet head that discharges the ink droplets for forming, and includes a nozzle row in which a plurality of nozzles for discharging the ink droplets of the forming ink is aligned in the sub scanning direction. In this case, the forming ink is for example the ink for forming the inside of the three-dimensional object. As the forming ink, for example, white-color ink can suitably be used. Further, in the present embodiment, the plurality of forming heads 406 is arranged along the main scanning direction with their positions in the sub scanning direction matched.

Notably, the respective ink jet heads in the head section 12 may be ink jet heads having identical configurations, other than the ink to be used, for example. Further, as these ink jet heads, well-known ink jet heads can suitably be used.

Further, as shown, in the present embodiment, the plurality of ultraviolet light sources 14 is arranged on both sides of the head section 12 to intervene it in between in the main scanning direction. Due to this, the plurality of ultraviolet light sources 14 irradiates for example the ultraviolet light during the main scanning operation onto the ink droplets that had struck the upper surface of the three-dimensional object 50 that is being formed.

By using the head section 12 configured as above, for example, the respective portions of the ink layers configuring the three-dimensional object 50 can suitably be formed by repeating the main scanning operations with the sub scanning operations in between. Further, due to this, for example, the specific color regions 202c to k can suitably be formed at the position that are to be the lateral side surface of the three-dimensional object 50. Due to this, according to the present embodiment, for example, the formation of the colored three-dimensional object 50 can be performed appropriately.

Further, in this case, the ink droplets of the respective colors can be discharged in different main scanning operations for each of the specific color regions 202c to k. For example, in the case of the depicted configuration, in the operation for forming the specific color regions 202c to k corresponding to the same position on the surface of the three-dimensional object 50, a first operation to discharge the ink droplets of the C color and the transparent color onto the specific color region 202c, a second operation to discharge the ink droplets of the M color and the transparent color onto the specific color region 202m, a third operation to discharge the ink droplets of the Y color and the transparent color onto the specific color region 202y, and a fourth operation to discharge the ink droplets of the K color and the transparent color onto the specific color region 202k can be performed separately in four different main scanning operations.

Further, in this case, since the different plurality of colored ink is not discharged at the same time onto each position of the three-dimensional object 50, even if the ink dots are formed for example at a high density in each of the main scanning operations, the different colors of ink are not mixed. Due to this, by configuring as above, for example, the specific color regions 202c to k being the regions of the respective colors can be formed in one pass (one pass per each color).

Further, in this case, by discharging the ink droplets of the transparent-color ink in addition to the respective colored ink, the amount of the ink to be discharged to each of the specific color regions 202c to k in each main scanning operation (ink amount per one pass print) can be set to a certain ink amount. Due to this, according to the present embodiment, the coloring for example can be performed more appropriately at a higher accuracy on the lateral side surface of the three-dimensional object 50.

Further, as described above, in the present embodiment, in the head section 12, the ultraviolet curing ink is used as the respective colored ink. Further, in this case, upon forming the respective ink layers, consideration may be given to not completely curing the ink dots formed by the ink droplet striking until when the main scanning operation for the respective portions of the head section 12 (coloring sections 302c to k and the forming section 304) is completed, and carrying out the irradiation of the ultraviolet light (UV exposure) at a degree by which they are not cured or not cured completely.

In this case, for example, in each main scanning operation, consideration may be given to only irradiating even a weaker ultraviolet light by the ultraviolet light sources 14, and bringing the ink dots to a half-cured (temporarily cured) state. Further, in this case, more specifically, for example, upon the striking of the ink droplets of the respective colors of CMYK, the ink dots may be cured to the half-cured state in which they are not completely cured by the ultraviolet light sources 14. Then, each time one layer with a preset thickness is formed and before the formation of the next ink layer is started, the ink dots configuring the one ink layer is irradiated further with the ultraviolet light by the ultraviolet light sources 14. Further, due to this, the curing of the ink dots configuring one ink layer is completed.

In the case of configuring as above, for example, by creating the half-cured state after the ink droplets of the respective colors have struck and before completely curing them, ink layers that are flattened and averaged can be formed. Further, in this case, since the ink layers that are sequentially formed more uniformly covers lower layers, for example, deficits caused upon the ink strike can more appropriately be averaged. Further, due to this, for example, the color change and the visibility of the base color can appropriately be suppressed. Due to this, by configuring as above, for example, the colored three-dimensional object 50 can be formed more appropriately.

Notably, half-curing the ink dots upon the striking of the ink droplets of the respective colors means to half-cure the ink dots during the main scanning operation during which the ink droplets were discharged, for example. Further, half-curing the ink dots means for example to cure the ink dots to a gelly state with viscosity by which they will not smear even when they contact with other ink, by irradiating the weak ultraviolet light at a degree by which the curing will not be completed. Further, completing the curing of the ink dots means for example to sufficiently cure the ink dots by irradiating the ultraviolet light equal to or more than a predetermined accumulated light amount.

Further, in the present embodiment, as above, the color change and the like is suppressed and the highly accurate coloring is realized by performing the coloring of the lateral side surfaces of the three-dimensional object 50 using the specific color regions 202c to k. However, to perform coloring with an even higher accuracy, it is desirable to set the moving speed Vh of the head section 12 in the main scanning operation to a speed that is equal to or less than a certain degree. Further, as for the moving speed Vh of the head section 12, for example, consideration may be given to setting it according to an initial speed Vt0 of the ink droplet discharge. In this case, more specifically, for example, Vh is preferably equal to or less than one-fiftieth ( 1/50) of Vt0.

Further, as for the moving speed Vh of the head section 12, consideration may also be given to setting it according to a speed Vt of the ink droplets upon striking onto the three-dimensional object 50 that is being formed. In this case, the speed Vt of the ink droplets upon striking means for example a speed in the ink droplet discharging direction. Further, in this case, more specifically, Vh is preferably equal to or less than one-twentieth ( 1/20) of Vt.

By configuring as these, for example, striking accuracy of the ink droplets can appropriately be increased. Further, due to this, for example, the specific color regions 202c to k, which are the regions of the respective colors, can be formed more appropriately at higher accuracy. Due to this, by configuring as above, for example, the color change or the base color visibility in the lateral side surfaces of the three-dimensional object 50 can more suitably be suppressed.

Further, as for the specific configuration of the head section 12, various modifications may be considered without limiting it to the configuration illustrated in FIG. 4A. For example, as for the arrangements of the coloring sections 302c to k and the forming section 304, they may be arranged other than FIG. 4A. Further, the order by which the coloring sections 302c to k and the forming section 304 are aligned and the order by which the ink jet heads configuring each of the coloring sections 302c to k and the forming section 304 and the like may suitably be modified.

Further, in the coloring sections 302c to k, the ink droplets of the respective colors and the transparent colors may be discharged by one ink jet head. FIG. 4B is a diagram that illustrates a variant of the configuration of the coloring sections 302c to k. Notably, in FIG. 4B, the configuration corresponding to each of the coloring sections 302c to k is indicated as the coloring section 302.

In the example illustrated in FIG. 4B, the coloring section 302 includes one coloring head 402. Further, the coloring head 402 includes a plurality of nozzle rows 502, 504 aligned along the main scanning direction with their positions in the sub scanning direction matched.

Between them, the nozzle row 502 is a nozzle row corresponding to the nozzle rows 502 of the coloring heads 402c to k in the configuration shown in FIG. 4A, and discharges the ink droplets of one of the CMYK colors. Further, the nozzle row 504 is a nozzle row corresponding to the nozzle rows 504 in the transparent-color heads 404, and discharges the ink droplets of the clear ink. Due to this, in the configuration illustrated in FIG. 4B, the coloring head 402 discharges the ink droplets of one of the CMYK colors and the ink droplets of the clear ink. In a case of configuring as above as well, similar to the case of using the configuration illustrated in FIG. 4A, the specific color regions 202c to k can suitably be formed. Further, due to this, the colored three-dimensional object 50 can suitably be formed.

As above, the present disclosure has been described by using embodiments, however, the technical scope of the present disclosure is not limited to the scope described in the embodiments. It is apparent to those skilled in the art that various modifications and improvements can be made to the above embodiments. It is apparent from the description of the claims that embodiment including such modifications and improvements are within the technical scope of the present disclosure.

### INDUSTRIAL APPLICABILITY

The present disclosure can suitably be applied for example to a three-dimensional object forming device.

What is claimed is:

1. A three-dimensional object forming device for forming a three-dimensional object that is at least in part colored by an additive manufacturing method, the three-dimensional object forming device comprising:
a head section that discharges ink droplets using an ink jet scheme;
a main-scan driver that causes the head section to perform a main scanning operation of discharging the ink droplets while moving in a preset main scanning direction; and
a controller that controls operations of the head section and the main-scan driver,
wherein the head section at least discharges the ink droplets of a plurality of colored ink for coloring and the ink droplets of transparent ink, the plurality of colors for the coloring at least comprising a first color and a second color that are different from each other,
the controller controls the operations of the head section and the main-scan driver so as to form a first color region being a region formed by the first colored ink and the transparent ink and a second color region being a region formed by the second colored ink and the transparent ink on a surface layer part of at least one of lateral side surfaces of the three-dimensional object, and
the first region is a region formed along the lateral side surface on the surface layer part, and the second region is a region formed along the lateral side surface at an inner side of the three-dimensional object with respect to the first region.

2. The three-dimensional object forming device according to claim 1, wherein
the plurality of colors for the coloring at least comprises the first color, the second color, a third color, and a fourth color that are different from each other,
the controller controls the operations of the head section and the main-scan driver so as to further form a third color region being a region formed by the third colored ink and the transparent ink and a fourth color region being a region formed by the fourth colored ink and the transparent ink on the surface layer part of the lateral side surface, and
the third region is a region formed along the lateral side surface at the inner side of the three-dimensional object with respect to the second region, and the fourth region is a region formed along the lateral side surface at the inner side of the three-dimensional object with respect to the third region.

3. The three-dimensional object forming device according to claim 1, wherein the controller controls the head section to discharge the ink droplets of the first color and the transparent color so that a total amount of the first colored ink and the transparent ink comes to be of a certain amount at each part of the first region.

4. The three-dimensional object forming device according to claim 1, wherein the controller controls the head section to discharge the ink droplets of one of the first color and the transparent color for each position in the first region in accordance with a color to be applied onto the lateral side surface of the three-dimensional object.

5. The three-dimensional object forming device according to claim 1, further comprising:
a sub-scan driver that moves the head section relative to the three-dimensional object in a sub scanning direction that intersects perpendicularly with the main scanning direction,
wherein the head section includes:
a first head being an ink jet head for discharging the ink droplets of at least the first color; and
a second head being an ink jet head for discharging the ink droplets of at least the second color, and
the second head is arranged so that its position in the sub scanning direction does not overlap with that of the first head.

6. The three-dimensional object forming device according to claim 1, further comprising:
an ultraviolet light source that irradiates ultraviolet light,
wherein the head section discharges ink droplets of ultraviolet curing ink as the ink droplets of each of the plurality of colors for the coloring and the transparent color,
the ultraviolet light source cures ink dots formed by struck ink to a half-cured state in which curing is not complete, upon when the ink droplets of the first color strikes and when the ink droplets of the second color strikes, and
each time one ink layer of a preset thickness is formed, the ultraviolet light source completes the curing of the ink dots configuring the one ink layer by further irradiating the ultraviolet light onto the ink dots configuring the one ink layer before formation of a subsequent ink layer is started.

7. The three-dimensional object forming device according to claim 1, wherein, in a case where a speed by which the head section moves in the main scanning direction during the main scanning operation is Vh, and an initial speed of ink droplet discharge by the head section is Vt0, Vh is equal to or less than 1/50 (one-fiftieth) of Vt0.

8. The three-dimensional object forming device according to of claim 1, wherein, in a case where a speed by which the head section moves in the main scanning direction during the main scanning operation is Vh, and a speed of the ink droplets upon striking onto the three-dimensional object during formation is Vt, Vh is equal to or less than 1/20 (one-twentieth) of Vt.

9. A three-dimensional object forming method for forming a three-dimensional object that is at least in part colored by an additive manufacturing method, the three-dimensional object forming method comprising:
causing a head section that discharges ink droplets using an ink jet scheme to perform a main scanning operation of discharging the ink droplets while moving in a preset main scanning direction;
the head section at least discharging the ink droplets of a plurality of colored ink for coloring and the ink droplets of transparent ink;
the plurality of colors for the coloring at least comprising a first color and a second color that are different from each other;
controlling an operation of the head section so as to form a first color region being a region formed by the first colored ink and the transparent ink and a second color region being a region formed by the second colored ink and the transparent ink on a surface layer part of at least one of lateral side surfaces of the three-dimensional object, and
the first region being a region formed along the lateral side surface on the surface layer part, and the second region being a region formed along the lateral side surface at an inner side of the three-dimensional object with respect to the first region.

10. The three-dimensional object forming device according to claim 2, wherein the controller controls the head section to discharge the ink droplets of the first color and the transparent color so that a total amount of the first colored ink and the transparent ink comes to be of a certain amount at each part of the first region.

11. The three-dimensional object forming device according to claim 2, wherein the controller controls the head section to discharge the ink droplets of one of the first color and the transparent color for each position in the first region in accordance with a color to be applied onto the lateral side surface of the three-dimensional object.

12. The three-dimensional object forming device according to claim 2, further comprising:
a sub-scan driver that moves the head section relative to the three-dimensional object in a sub scanning direction that intersects perpendicularly with the main scanning direction,
wherein the head section includes:
a first head being an ink jet head for discharging the ink droplets of at least the first color; and
a second head being an ink jet head for discharging the ink droplets of at least the second color, and
the second head is arranged so that its position in the sub scanning direction does not overlap with that of the first head.

13. The three-dimensional object forming device according to claim 2, further comprising:
an ultraviolet light source that irradiates ultraviolet light,
wherein the head section discharges ink droplets of ultraviolet curing ink as the ink droplets of each of the plurality of colors for the coloring and the transparent color,
the ultraviolet light source cures ink dots formed by struck ink to a half-cured state in which curing is not complete, upon when the ink droplets of the first color strikes and when the ink droplets of the second color strikes, and
each time one ink layer of a preset thickness is formed, the ultraviolet light source completes the curing of the ink dots configuring the one ink layer by further irradiating the ultraviolet light onto the ink dots configuring the one ink layer before formation of a subsequent ink layer is started.

14. The three-dimensional object forming device according to claim 2, wherein, in a case where a speed by which the head section moves in the main scanning direction during the main scanning operation is Vh, and an initial speed of ink droplet discharge by the head section is Vt0, Vh is equal to or less than 1/50 (one-fiftieth) of Vt0.

15. The three-dimensional object forming device according to of claim 2, wherein, in a case where a speed by which the head section moves in the main scanning direction during the main scanning operation is Vh, and a speed of the ink droplets upon striking onto the three-dimensional object during formation is Vt, Vh is equal to or less than 1/20 (one-twentieth) of Vt.
